(19) United States
(12) Patent Application Publication
(10) Pub. No.: US 2023/0189053 A1
(43) Pub. Date: Jun. 15, 2023

(54) APPARATUS, METHOD, AND COMPUTER PROGRAM

(71) Applicant: NOKIA TECHNOLOGIES OY, Espoo (FI)

(72) Inventors: Rajesh Babu NATARAJAN, Bangalore (IN); Gayathri TADAS, Bengaluru (IN); Kavitha NANJANGUD KEERTHI, Bangalore (IN); Alessio CASATI, West Molesey Surrey (GB)

(21) Appl. No.: 17/920,912

(22) PCT Filed: Apr. 27, 2021
(86) PCT No.: PCT/EP2021/060963

§ 371 Date: Oct. 24, 2022

(30) Foreign Application Priority Data
May 2, 2020 (IN) 202041018831

(51) Int. Cl. H04W 28/02

(52) U.S. Cl. CPC H04W 28/0257

(57) ABSTRACT

An apparatus comprising: at least one processor; and at least one memory including computer program code; the at least one memory and the computer program code configured to, with the at least one processor, cause the apparatus at least to: determine (1100) that an aggregate bit rate for a network slice reached a threshold value; and adjust (1102) at least one of a maximum bit rate per terminal for the network slice or a maximum number of terminals allowed to operate on the network slice.

### FIELD OF THE DISCLOSURE

The present disclosure relates to an apparatus, a method, and a computer program for adjusting at least one of a maximum bit rate per terminal for a network slice or a maximum number of terminals allowed to operate on the network slice in a cellular system.

### BACKGROUND

A communication system can be seen as a facility that enables communication sessions between two or more entities such as user terminals, base stations/access points and/or other nodes by providing carriers between the various entities involved in the communications path. A communication system can be provided for example by means of a communication network and one or more compatible communication devices. The communication sessions may comprise, for example, communication of data for carrying communications such as voice, electronic mail (email), text message, multimedia and/or content data and so on. Non-limiting examples of services provided comprise two-way or multi-way calls, data communication or multimedia services and access to a data network system, such as the Internet. In a wireless communication system at least a part of a communication session between at least two stations occurs over a wireless link.

A user can access the communication system by means of an appropriate communication device or terminal. A communication device of a user is often referred to as user equipment (UE) or user device. A communication device is provided with an appropriate signal receiving and transmitting apparatus for enabling communications, for example enabling access to a communication network or communications directly with other users. The communication device may access a carrier provided by a station or access point, and transmit and/or receive communications on the carrier.

The communication system and associated devices typically operate in accordance with a required standard or specification which sets out what the various entities associated with the system are permitted to do and how that should be achieved. Communication protocols and/or parameters which shall be used for the connection are also typically defined. One example of a communications system is UTRAN (3G radio). Another example of an architecture that is known as the long-term evolution (LTE) or the Universal Mobile Telecommunications System (UMTS) radio-access technology. Another example communication system is so called 5G radio or new radio (NR) access technology.

### SUMMARY

According to an aspect there is provided an apparatus comprising at least one processor and at least one memory including computer code for one or more programs, the at least one memory and the computer code configured, with the at least one processor, to cause the apparatus at least to: determine that an aggregate bit rate for a network slice reached a threshold value; and adjust at least one of a maximum bit rate per terminal for the network slice or a maximum number of terminals allowed to operate on the network slice.

The at least one memory and the computer program code may be configured to, with the at least one processor, cause the apparatus at least to: adjust the maximum number of terminals allowed to operate on the network slice whilst abstaining from adjusting the maximum bit rate per terminal for the network slice.

The threshold value may comprise a lower threshold value and/or an upper threshold value.

Determining that an aggregate bit rate for a network slice reached the threshold value may comprise: determining that an aggregate bit rate for a network slice reached the threshold value based on a number of terminals operating on the network slice and the maximum bit rate per terminal for the network slice.

The at least one memory and the computer program code may be configured to, with the at least one processor, cause the apparatus at least to: enforce the maximum number of terminals allowed to operate on the network slice.

The at least one memory and the computer program code may be configured to, with the at least one processor, cause the apparatus at least to: provide a notification indicating the adjusted maximum bit rate per terminal for the network slice.

The at least one memory and the computer program code may be configured to, with the at least one processor, cause the apparatus at least to: determine the number of terminals operating on the network slice.

Determining the number of terminals operating on the network slice may comprise: determining that a first packet data unit session is established by a terminal for the network slice; and increment the number of terminals operating on the network slice.

Determining the number of terminals operating on the network slice may comprise: determining that a last packet data unit session is released by a terminal for the network slice; and decrement the number of terminals operating on the network slice.

The apparatus may be a policy control function serving the network slice.

The apparatus may be a single policy control function serving the network slice.

The apparatus may be one of a plurality of policy control functions serving the network slice; and another one of the plurality of policy control function is registered with the apparatus to receive the notification indicating the adjusted maximum bit rate per terminal for the network slice from the apparatus.

The maximum bit rate per terminal for the network slice may be different from a subscribed maximum bit rate per terminal for the network slice.

The aggregate bit rate for the network slice may be an aggregate bit rate for the network slice for an uplink; the threshold value may be a threshold value for the uplink; and the maximum bit rate per terminal for the network slice may comprise a maximum bit rate per terminal for the network slice for the uplink.

The aggregate bit rate for the network slice is an aggregate bit rate for the network slice for a downlink; the threshold value may be a threshold value for the downlink; and the maximum bit rate per terminal for the network slice may comprise a maximum bit rate per terminal for the network slice for the downlink.

According to an aspect there is provided an apparatus comprising means for: determining that an aggregate bit rate for a network slice reached a threshold value; and adjusting at least one of a maximum bit rate per terminal for the network slice or a maximum number of terminals allowed to operate on the network slice.

The apparatus may comprise means for: adjusting the maximum number of terminals allowed to operate on the network slice whilst abstaining from adjusting the maximum bit rate per terminal for the network slice.

The threshold value may comprise a lower threshold value and/or an upper threshold value.

Determining that an aggregate bit rate for a network slice reached the threshold value may comprise: determining that an aggregate bit rate for a network slice reached the threshold value based on a number of terminals operating on the network slice and the maximum bit rate per terminal for the network slice.

The apparatus may comprise means for: enforcing the maximum number of terminals allowed to operate on the network slice.

The apparatus may comprise means for: providing a notification indicating the adjusted maximum bit rate per terminal for the network slice.

The apparatus may comprise means for: determining the number of terminals operating on the network slice.

Determining the number of terminals operating on the network slice may comprise: determining that a first packet data unit session is established by a terminal for the network slice; and increment the number of terminals operating on the network slice.

Determining the number of terminals operating on the network slice may comprise: determining that a last packet data unit session is released by a terminal for the network slice; and decrement the number of terminals operating on the network slice.

The apparatus may be a policy control function serving the network slice.

The apparatus may be a single policy control function serving the network slice.

The apparatus may be one of a plurality of policy control functions serving the network slice; and another one of the plurality of policy control function is registered with the apparatus to receive the notification indicating the adjusted maximum bit rate per terminal for the network slice from the apparatus.

The maximum bit rate per terminal for the network slice may be different from a subscribed maximum bit rate per terminal for the network slice.

The aggregate bit rate for the network slice may be an aggregate bit rate for the network slice for an uplink; the threshold value may be a threshold value for the uplink; and the maximum bit rate per terminal for the network slice may comprise a maximum bit rate per terminal for the network slice for the uplink.

The aggregate bit rate for the network slice is an aggregate bit rate for the network slice for a downlink; the threshold value may be a threshold value for the downlink; and the maximum bit rate per terminal for the network slice may comprise a maximum bit rate per terminal for the network slice for the downlink.

According to an aspect there is provided an apparatus comprising circuitry configured to determine that an aggregate bit rate for a network slice reached a threshold value; and adjust at least one of a maximum bit rate per terminal for the network slice or a maximum number of terminals allowed to operate on the network slice.

The apparatus may circuitry configured to: adjust the maximum number of terminals allowed to operate on the network slice whilst abstaining from adjusting the maximum bit rate per terminal for the network slice.

The threshold value may comprise a lower threshold value and/or an upper threshold value.

Determining that an aggregate bit rate for a network slice reached the threshold value may comprise: determining that an aggregate bit rate for a network slice reached the threshold value based on a number of terminals operating on the network slice and the maximum bit rate per terminal for the network slice.

The apparatus may comprise circuitry configured to: enforce the maximum number of terminals allowed to operate on the network slice.

The apparatus may comprise circuitry configured to: provide a notification indicating the adjusted maximum bit rate per terminal for the network slice.

The apparatus may comprise circuitry configured to: determine the number of terminals operating on the network slice.

Determining the number of terminals operating on the network slice may comprises: determining that a first packet data unit session is established by a terminal for the network slice; and increment the number of terminals operating on the network slice.

Determining the number of terminals operating on the network slice may comprise: determining that a last packet data unit session is released by a terminal for the network slice; and decrement the number of terminals operating on the network slice.

The apparatus may be a policy control function serving the network slice.

The apparatus may be a single policy control function serving the network slice.

The apparatus may be one of a plurality of policy control functions serving the network slice; and another one of the plurality of policy control function is registered with the apparatus to receive the notification indicating the adjusted maximum bit rate per terminal for the network slice from the apparatus.

The maximum bit rate per terminal for the network slice may be different from a subscribed maximum bit rate per terminal for the network slice.

The aggregate bit rate for the network slice may be an aggregate bit rate for the network slice for an uplink; the threshold value may be a threshold value for the uplink; and the maximum bit rate per terminal for the network slice may comprise a maximum bit rate per terminal for the network slice for the uplink.

The aggregate bit rate for the network slice is an aggregate bit rate for the network slice for a downlink; the threshold value may be a threshold value for the downlink; and the maximum bit rate per terminal for the network slice may comprise a maximum bit rate per terminal for the network slice for the downlink.

According to an aspect there is provided a method comprising: determining that an aggregate bit rate for a network slice reached a threshold value; and adjusting at least one of a maximum bit rate per terminal for the network slice or a maximum number of terminals allowed to operate on the network slice.

The method may comprise: adjusting the maximum number of terminals allowed to operate on the network slice whilst abstaining from adjusting the maximum bit rate per terminal for the network slice.

The threshold value may comprise a lower threshold value and/or an upper threshold value.

Determining that an aggregate bit rate for a network slice reached the threshold value may comprise: determining that an aggregate bit rate for a network slice reached the threshold value based on a number of terminals operating on the network slice and the maximum bit rate per terminal for the network slice.

The method may comprise: enforcing the maximum number of terminals allowed to operate on the network slice.

The method may comprise: providing a notification indicating the adjusted maximum bit rate per terminal for the network slice.

The method may comprise: determining the number of terminals operating on the network slice.

Determining the number of terminals operating on the network slice may comprises: determining that a first packet data unit session is established by a terminal for the network slice; and increment the number of terminals operating on the network slice.

Determining the number of terminals operating on the network slice may comprise: determining that a last packet data unit session is released by a terminal for the network slice; and decrement the number of terminals operating on the network slice.

The method may be performed by policy control function serving the network slice.

The method may be performed by a single policy control function serving the network slice.

The method may be performed by one of a plurality of policy control functions serving the network slice; and another one of the plurality of policy control function is registered with the apparatus to receive the notification indicating the adjusted maximum bit rate per terminal for the network slice from the apparatus.

The maximum bit rate per terminal for the network slice may be different from a subscribed maximum bit rate per terminal for the network slice.

The aggregate bit rate for the network slice may be an aggregate bit rate for the network slice for an uplink; the threshold value may be a threshold value for the uplink; and the maximum bit rate per terminal for the network slice may comprise a maximum bit rate per terminal for the network slice for the uplink.

The aggregate bit rate for the network slice is an aggregate bit rate for the network slice for a downlink; the threshold value may be a threshold value for the downlink; and the maximum bit rate per terminal for the network slice may comprise a maximum bit rate per terminal for the network slice for the downlink.

According to an aspect there is provided a computer program comprising computer executable code which when run on at least one processor is configured to: determine that an aggregate bit rate for a network slice reached a threshold value; and adjust at least one of a maximum bit rate per terminal for the network slice or a maximum number of terminals allowed to operate on the network slice.

The computer program may comprise computer executable code which when run on at least one processor is configured to: adjust the maximum number of terminals allowed to operate on the network slice whilst abstaining from adjusting the maximum bit rate per terminal for the network slice.

The threshold value may comprise a lower threshold value and/or an upper threshold value.

Determining that an aggregate bit rate for a network slice reached the threshold value may comprise: determining that an aggregate bit rate for a network slice reached the threshold value based on a number of terminals operating on the network slice and the maximum bit rate per terminal for the network slice.

The computer program may comprise computer executable code which when run on at least one processor is configured to: enforce the maximum number of terminals allowed to operate on the network slice.

The computer program may comprise computer executable code which when run on at least one processor is configured to: provide a notification indicating the adjusted maximum bit rate per terminal for the network slice.

The computer program may comprise computer executable code which when run on at least one processor is configured to: determine the number of terminals operating on the network slice.

Determining the number of terminals operating on the network slice may comprise: determining that a first packet data unit session is established by a terminal for the network slice; and increment the number of terminals operating on the network slice.

Determining the number of terminals operating on the network slice may comprise: determining that a last packet data unit session is released by a terminal for the network slice; and decrement the number of terminals operating on the network slice.

The at least one processor may be part of a policy control function serving the network slice.

The at least one processor may be part of a single policy control function serving the network slice.

The at least one processor may be part of one of a plurality of policy control functions serving the network slice; and another one of the plurality of policy control function is registered with the apparatus to receive the notification indicating the adjusted maximum bit rate per terminal for the network slice from the apparatus.

The maximum bit rate per terminal for the network slice may be different from a subscribed maximum bit rate per terminal for the network slice.

The aggregate bit rate for the network slice may be an aggregate bit rate for the network slice for an uplink; the threshold value may be a threshold value for the uplink; and the maximum bit rate per terminal for the network slice may comprise a maximum bit rate per terminal for the network slice for the uplink.

The aggregate bit rate for the network slice is an aggregate bit rate for the network slice for a downlink; the threshold value may be a threshold value for the downlink; and the maximum bit rate per terminal for the network slice may comprise a maximum bit rate per terminal for the network slice for the downlink.

According to an aspect there is provided an apparatus comprising at least one processor and at least one memory including computer code for one or more programs, the at least one memory and the computer code configured, with the at least one processor, to cause the apparatus at least to: receive a notification indicating an adjusted maximum bit rate per terminal for a network slice; and provide the notification indicating the adjusted maximum bit rate per terminal for the network slice.

The apparatus may be one of a plurality of policy control functions serving the network slice; and registered with another one of the plurality of policy control functions serving the network slice to receive the notification indicating the adjusted maximum bit rate per terminal for the network slice.

The at least one memory and the computer program code may be configured to, with the at least one processor, cause the apparatus at least to: trigger a packet data unit session modification procedure based on the adjusted maximum bit rate per terminal for the network slice.

The at least one memory and the computer program code are configured to, with the at least one processor, cause the apparatus at least to: trigger a packet data unit session establishment procedure based on the adjusted maximum bit rate per terminal for the network slice.

According to an aspect there is provided an apparatus comprising means for: receiving a notification indicating an adjusted maximum bit rate per terminal for a network slice; and providing the notification indicating the adjusted maximum bit rate per terminal for the network slice.

The apparatus may be one of a plurality of policy control functions serving the network slice; and registered with another one of the plurality of policy control functions serving the network slice to receive the notification indicating the adjusted maximum bit rate per terminal for the network slice.

The apparatus may comprise means for: triggering a packet data unit session modification procedure based on the adjusted maximum bit rate per terminal for the network slice.

The apparatus may comprise means for: triggering a packet data unit session establishment procedure based on the adjusted maximum bit rate per terminal for the network slice.

According to an aspect there is provided an apparatus comprising circuitry configured to: receive a notification indicating an adjusted maximum bit rate per terminal for a network slice; and provide the notification indicating the adjusted maximum bit rate per terminal for the network slice.

The apparatus may be one of a plurality of policy control functions serving the network slice; and registered with another one of the plurality of policy control functions serving the network slice to receive the notification indicating the adjusted maximum bit rate per terminal for the network slice.

The apparatus may comprise circuitry configured to: trigger a packet data unit session modification procedure based on the adjusted maximum bit rate per terminal for the network slice.

The apparatus may comprise circuitry configured to: trigger a packet data unit session establishment procedure based on the adjusted maximum bit rate per terminal for the network slice.

According to an aspect there is provided a method comprising: receiving a notification indicating an adjusted maximum bit rate per terminal for a network slice; and providing the notification indicating the adjusted maximum bit rate per terminal for the network slice.

The method may be performed by one of a plurality of policy control functions serving the network slice; and registered with another one of the plurality of policy control functions serving the network slice to receive the notification indicating the adjusted maximum bit rate per terminal for the network slice.

The method may comprise: triggering a packet data unit session modification procedure based on the adjusted maximum bit rate per terminal for the network slice.

The method may comprise: triggering a packet data unit session establishment procedure based on the adjusted maximum bit rate per terminal for the network slice.

According to an aspect there is provided a computer program comprising computer executable code which when run on at least one processor is configured to: receive a notification indicating an adjusted maximum bit rate per terminal for a network slice; and provide the notification indicating the adjusted maximum bit rate per terminal for the network slice.

The at least one processor may be part of one of a plurality of policy control functions serving the network slice; and registered with another one of the plurality of policy control functions serving the network slice to receive the notification indicating the adjusted maximum bit rate per terminal for the network slice.

The computer program may comprise computer executable code which when run on at least one processor is configured to: trigger a packet data unit session modification procedure based on the adjusted maximum bit rate per terminal for the network slice.

The computer program may comprise computer executable code which when run on at least one processor is configured to: trigger a packet data unit session establishment procedure based on the adjusted maximum bit rate per terminal for the network slice.

According to an aspect there is provided an apparatus comprising at least one processor and at least one memory including computer code for one or more programs, the at least one memory and the computer code configured, with the at least one processor, to cause the apparatus at least to: receive a notification indicating an adjusted maximum bit rate per terminal for a network slice; and enforce the adjusted maximum bit rate per terminal for the network slice.

Enforcing the adjusted maximum bit rate per terminal for the network slice may comprise: triggering a packet data unit session modification procedure based on the adjusted maximum bit rate per terminal for the network slice.

Enforcing the adjusted maximum bit rate per terminal for the network slice may comprise: triggering a packet data unit session establishment procedure based on the adjusted maximum bit rate per terminal for the network slice.

According to an aspect there is provided an apparatus comprising means for: receiving a notification indicating an adjusted maximum bit rate per terminal for a network slice; and enforcing the adjusted maximum bit rate per terminal for the network slice.

According to an aspect there is provided an apparatus comprising circuitry configured to: receive a notification indicating an adjusted maximum bit rate per terminal for a network slice; and enforce the adjusted maximum bit rate per terminal for the network slice.

According to an aspect there is provided a method comprising: receiving a notification indicating an adjusted maximum bit rate per terminal for a network slice; and enforcing the adjusted maximum bit rate per terminal for the network slice.

According to an aspect there is provided a computer program comprising computer executable code which when run on at least one processor is configured to: receive a notification indicating an adjusted maximum bit rate per terminal for a network slice; and enforce the adjusted maximum bit rate per terminal for the network slice.

According to an aspect, there is provided a computer readable medium comprising program instructions stored thereon for performing at least one of the above methods.

According to an aspect, there is provided a non-transitory computer readable medium comprising program instructions stored thereon for performing at least one of the above methods.

According to an aspect, there is provided a non-volatile tangible memory medium comprising program instructions stored thereon for performing at least one of the above methods.

In the above, many different aspects have been described. It should be appreciated that further aspects may be provided by the combination of any two or more of the aspects described above.

Various other aspects are also described in the following detailed description and in the attached claims.

List of abbreviations

| | |
|---|---|
| AF: | Application Function |
| AMBR: | Aggregate Maximum Bit Rate |
| AMF: | Access Management Function |
| AUSF: | Authentication Server Function |
| BS: | Base Station |
| CU: | Centralized Unit |
| DL: | Downlink |
| DN: | Data Network |
| DU: | Distributed Unit |
| eNB: | eNodeB |
| GBR: | Guaranteed Bit Rate |
| GFBR: | Guaranteed Flow Bit Rate |
| gNB: | gNodeB |
| GSM: | Global System for Mobile communication |
| GSMA: | Global System for Mobile communication Association |
| GST: | Generic Network SliceTemplate |
| HSS: | Home Subscriber Server |
| IoT: | Internet of Things |
| LTE: | Long Term Evolution |
| MFBR: | Maximum Flow Bit Rate |
| NEF: | Network Exposure Function |
| NEST: | Network Slice Type |
| NR: | New radio |
| NSSF: | Network Slice Selection Function |
| MAC: | Medium Access Control |
| MS: | Mobile Station |
| MTC: | Machine Type Communication |
| NF: | Network Function |
| NG: | New Generation |
| NPN: | Non-Private Network |
| PCF: | Policy Control Function |
| PDU: | Packet Data Unit |
| PLMN: | Public Land Mobile Network |
| QoS: | Quality of Service |
| RAM: | Random Access Memory |
| RAN: | Radio Access Network |
| RF: | Radio Frequency |
| ROM: | Read Only Memory |
| SLA: | Service Level Agreement |
| SMF: | Session Management Function |
| S-NSSAI: | Single Network Slice Selection Assistance Information |
| TS: | Technical Specification |
| UDM: | User Data Management |
| UE: | User Equipment |
| UL: | Uplink |
| UPF: | User Plane Function |
| UMTS: | Universal Mobile Telecommunication System |
| USB: | Universal |
| 3GPP: | 3^{rd} Generation Partnership Project |
| 5G: | 5^{th} Generation |
| 5GCN: | 5G Core network |
| 5GRAN: | 5G Radio Access Network |
| 5GS: | 5G System |

### References

TS 23.501 - 5G; System Architecture for the 5G System;
TS 23 502 - 5G; Procedures for the 5G System
TS 23 503 - 5G; Policy and Charging Control Framework for the 5G System; Stage 2
TS 29.518 - 5G System; Access and Mobility Management Services; Stage 3
TS 23.221 - Architectural requirements
TS 38.300 - NR; Overall description; Stage-2

### BRIEF DESCRIPTION OF THE FIGURES

Embodiments will now be described, by way of example only, with reference to the accompanying Figures in which:

FIG. 1 shows a schematic representation of a 5G system;

FIG. 2 shows a schematic representation of a control apparatus;

FIG. 3 shows a schematic representation of a terminal;

FIG. 4 shows a schematic representation of a first deployment scenario wherein a terminal has a single subscribed network slice in a private network or a non-private network deployment with a single user plane function/data network for the network slice;

FIG. 5 shows another schematic representation of a second deployment scenario wherein a terminal subscribes with multiple network slices and dedicated network functions for each network slice;

FIG. 6 shows a schematic representation of a third deployment scenario wherein a terminal subscribes with a single network slice and multiple network functions serve each network slice with one master policy control function elected per network slice;

FIG. 7 shows a schematic representation of a fourth deployment scenario wherein a terminal subscribes with multiple network slices and multiple network function serve each network slice with one master policy control function elected for multiple network slices;

FIG. 8 shows a schematic representation of a signalling diagram of a process for providing notifications from a master policy control function to a serving policy control function;

FIGS. 9a and 9b show a schematic representation of a signalling diagram of a process for establishing a packet data unit session as per FIG. 4.3.2.2.1-1 from TS 23.502;

FIGS. 10a and 10b show a schematic representation of a signalling diagram of a process for modifying a packet data unit session as per FIG. 4.3.3.2-1 from TS 23.502;

FIG. 11 shows a schematic representation of a block diagram of a method performed by a master policy control function for providing a notification indicating an adjusted maximum bit rate per terminal for a network slice to a serving policy control function or an access network node.

FIG. 12 shows a schematic representation of a block diagram of a method performed by a serving policy control function for providing a notification indicating an adjusted maximum bit rate per terminal for a network slice to an access network node;

FIG. 13 shows a schematic representation of a block diagram of a method performed by an access network node for enforcing at least one of an adjusted maximum bit rate per terminal for a network slice; and

FIG. 14 shows a schematic representation of a non-volatile memory medium storing instructions which when executed by a processor allow a processor to perform one or more of the steps of the methods of FIGS. 11 to 13.

### DETAILED DESCRIPTION OF THE FIGURES

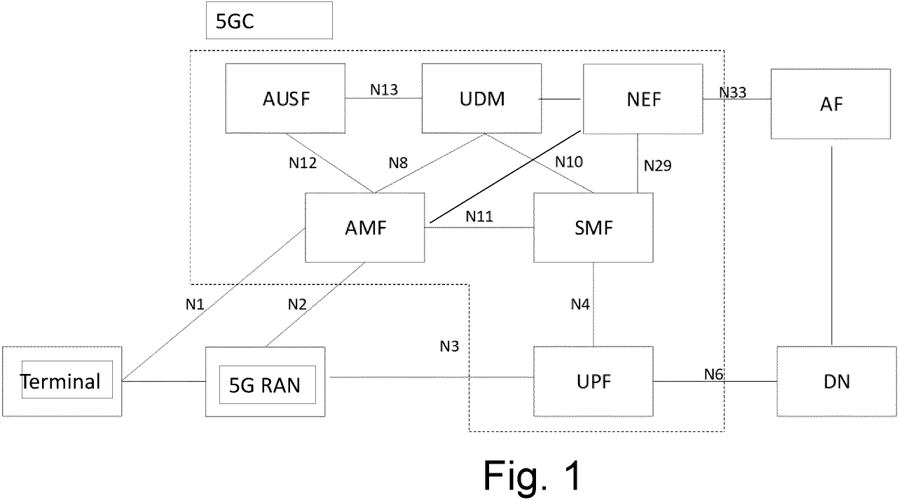

In the following certain embodiments are explained with reference to mobile communication devices capable of communication via a wireless cellular system and mobile communication systems serving such mobile communication devices. Before explaining in detail the exemplifying embodiments, certain general principles of a wireless communication system, access systems thereof, and mobile communication devices are briefly explained with reference to FIGS. 1, 2 and 3 to assist in understanding the technology underlying the described examples.

FIG. 1 shows a schematic representation of a 5G system (5GS). The 5GS may comprises a terminal, a 5G radio access network (5GRAN), a 5G core network (5GCN), one or more application function (AF) and one or more data networks (DN).

The 5GRAN may comprise one or more gNodeB (GNB) distributed unit functions connected to one or more gNodeB (GNB) centralized unit functions.

The 5GCN may comprise an access management function (AMF), a session management function (SMF), an authentication server function (AUSF), a user data management (UDM), a user plane function (UPF) and/or a network exposure function (NEF). The 5GCN may also comprise a network slice selection funcion (NSSF) and/or a policy control function (PCF), although they are not represented.

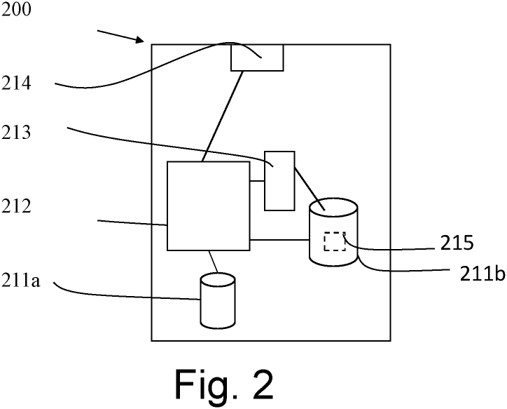

FIG. 2 illustrates an example of a control apparatus 200 for controlling a function of the 5GRAN or the 5GCN as illustrated on FIG. 1. The control apparatus may comprise at least one random access memory (RAM) 211a, at least on read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b. The control apparatus 200 may be interconnected with another control apparatus 200 controlling another function of the 5GRAN or the 5GCN. In some embodiments, each function of the 5GRAN or the 5GCN comprises a control apparatus 200. In alternative embodiments, two or more functions of the 5GRAN or the 5GCN may share a control apparatus.

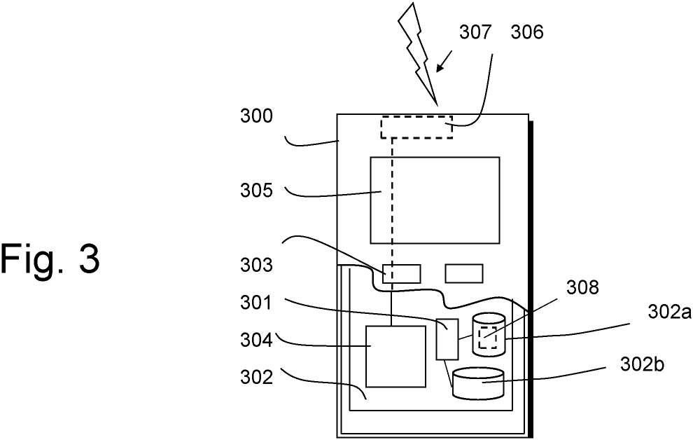

FIG. 3 illustrates an example of a terminal 300, such as the terminal illustrated on FIG. 1. The terminal 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, a Cellular Internet of things (CloT) device or any combinations of these or the like. The terminal 300 may provide, for example, communication of data for carrying communications. The communications may be one or more of voice, electronic mail (email), text message, multimedia, data, machine data and so on.

The terminal 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The terminal 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302a and the ROM 211b. The at least one processor 301 may be configured to execute an appropriate software code 308. The software code 308 may for example allow to perform one or more of the present aspects. The software code 308 may be stored in the ROM 302b.

The processor, storage and other relevant control apparatus can be provided on an appropriate circuit board and/or in chipsets. This feature is denoted by reference 304. The device may optionally have a user interface such as keypad 305, touch sensitive screen or pad, combinations thereof or the like. Optionally one or more of a display, a speaker and a microphone may be provided depending on the type of the device.

Global System for Mobile Association (GSMA) new generation (NG) NG.116 has introduced the concept of generic network slice template (GST) from which several network slice types (NESTs) can be derived by assigning values to applicable attributes defined in the GST.

In this context, GST defined attributes to limit the maximum data rate per UE supported by the network slice in downlink (DL) and uplink (UL). These parameters could be used to offer different contract qualities like gold, silver and bronze.

For example: maximum data rate per UE supported by the network slice in downlink and uplink may be described with the parameters below:

| | |
|---|---|
| Value | Integer |
| Measurement Unit | Kps |
| Example | 100Mbps 20 Gbps |
| Tags | Scalability attributes KP |

As per TS 23.501 section 5.7.2.5:
For guaranteed bit rate (GBR) quality of service (QoS) flows only, the following additional QoS parameters may exist:
   Guaranteed flow bit rate (GFBR) in UL and DL;
   Maximum flow bit rate (MFBR) in UL and DL.

The GFBR may denotes the bit rate that is guaranteed to be provided by the network to the QoS flow over an averaging time window. The MFBR may limit the bit rate to the highest bit rate that is expected by the QoS Flow.

GFBR and MFBR may be signaled to the (R)AN in a QoS profile and signaled to a UE as QoS flow level QoS parameter for each individual QoS Flow.

As per TS 23.501 section 5.7.2.6:
Each packet data unit (PDU) PDU session of a UE may be associated with the following aggregate rate limit QoS parameter:
   per Session Aggregate Maximum Bit Rate (Session-AMBR).

The Session-AMBR may limit the aggregate bit rate that can be expected to be provided across all Non-GBR QoS Flows for a specific PDU Session.

Each UE may associated with the following aggregate rate limit QoS parameter:
per UE Aggregate Maximum Bit Rate (UE-AMBR).

The UE-AMBR may limit the aggregate bit rate that can be expected to be provided across all Non-GBR QoS Flows of a UE.

As per TS 38.300 section 16.3.1:

The support of network slicing may rely on the principle that traffic for different slices is handled by different PDU sessions.

Slice awareness in NG-RAN may be introduced at UE level by indicating the list of allowed single network slice selection assistance information (S-NSSAI) for the UE to the RAN, and at PDU session level, by indicating the S-NSSAI corresponding to the PDU session, in all signaling containing PDU session resource information.

As per TS 38.300 section 16.3.4.4:

One S-NSSAI may be added per PDU session to be established, so NG-RAN is enabled to apply policies at PDU session level according to the service level agreement (SLA) represented by the network slice, while still being able to apply (for example) differentiated QoS within the slice.

One or more aspects of this disclosure relate to techniques for allowing a network to control aggregate bit rate in UL and DL on a network slice.

One or more aspects of this disclosure relate to techniques for allowing a network to ensure fairness across UE data rates in a public land mobile network (PLMN) when a maximum bit rate for a network slice in the DL or UL is reached.

As per TR 23.700-40, related key issue # 5 is defined for dynamic adjustment of maximum bit rate per UE for a network slice and trigger fairness among the UE’s.

One or more aspects of this disclosure relate to the problem of whether and how to adjust maximum bit rate per UE for a network slice?

One or more aspects of this disclosure relate to the problem of whether and how to adjust total number of UEs operating in a network slice?

One or more aspects of this disclosure relate to a UE using a S-NSSAI (allowed NSSAI) identifying a network slice and subject to a maximum bit rate control.

A number of UEs per slice may be counted. A master policy control function (PCF) may only count the number of UEs for a S-NSSAI with an established PDU sessions, for the S-NSSAIs it is configured to do so.

Moreover, when a PDU session is established, the master PCF may detect whether the PDU session belongs to an existing UE in a network slice identified by the S-NSSAI. If not, the master PCF may increment the number of UEs for the network slice identified by the S-NSSAI. If a last PDU session for a UE in the S_NSSAI is removed, the master PCF decrements the number of UEs for the network slice identified by the S-NSSAI.

If there is configured just a single PCF for the entire Network slice, then the PCF may act as a master PCF. Otherwise, a master PCF may be selected among PCFs serving the network slice and all the other PCFs serving the network slice will register with the master PCF.

The master PCF may be configured with a maximum bit rate for a S-NSSAI. To enforce this, it may set a dynamic maximum bit rate per UE for a network slice identified by the S-NSSAI (dynamic UE-Slice-MBR) so that the maximum bit rate per UE for the network slice is not overflown in DL or UL.

The dynamic maximum bit rate per UE for a network slice (dynamic UE-Slice-MBR) set by the master PCF may not be higher than a subscribed maximum bit rate per UE for a network slice (subscribed UE-Slice-MBR), if a UE subscription includes this indication.

This dynamic maximum bit rate per UE for a network slice (dynamic UE-Slice-MBR) may be changed according to local policy that may imply some hysteresis.

All the PCF serving the network slice may subscribe with the master PCF for a service to get notification of changes to the dynamic maximum bit rate per UE for a network slice (dynamic UE-Slice-MBR) for a S-NSSAI. The master PCF may compute the dynamic maximum bit rate per UE for a network slice (dynamic UE-Slice-MBR) based on policy to not overflow the maximum bit rate for a network slice (dynamic UE-Slice-MBR) for the S-NSSAI.

During the notification, the master PCF may indicate the dynamic maximum bit rate per UE for a network slice (dynamic UE-Slice-MBR) to be enforced.

The dynamic maximum bit rate per UE for a network slice (dynamic UE-Slice-MBR) may be derived by the master PCF based on an aggregate bit rate for a network slice and a number of active UE’s in the network slice.

The dynamic maximum bit rate per UE for a network slice (dynamic UE-Slice-MBR) may be different from the subscribed maximum bit rate per UE for a network slice (subscribed UE-Slice-MBR). In fact, a UE may not have any such subscribed maximum bit rate per UE for a network slice (subscribed UE-Slice-MBR).

Alternatively, the dynamic maximum bit rate per UE for a network slice (dynamic UE-Slice-MBR) may be static and kept constant and the number of UEs admitted to operate on a network slice may be modified by the master PCF to ensure that an aggregate bit rate for a network slice is lower than a maximum aggregate bit rate for a network slice. The master PCF may restrict any new UE requesting a PDU session in the S-NSSAI until the master PCF indicates this is possible again.

The dynamic maximum bit rate per UE for a network slice (dynamic UE-Slice-MBR) may be passed from a serving PCF to the NG-RAN via a SMF and a AMF (in N2 SM information) (see TS 23.502, section 4.3.2.2 - step 12 - for PDU session establishment procedure) and (TS 23.502, section 4.3.2.3 - step 4 - for Network triggered PDU session modification procedure).

Depending on the signalling load (i.e. whether aggregate bit rate for a network slice is lower than a maximum aggregate bit rate for a network slice) and UE activity (i.e. number of UEs operating on a network slice), a serving PCF may initiate network initiated PDU session modification for the already operating UEs to apply an adjusted dynamic maximum bit rate per UE for a network slice (dynamic UE-Slice-MBR) in the DL or the UL, so that it does not impact in anyways to a 5GS system load.

The NG-RAN may enforce the dynamic maximum bit rate per UE for a network slice (dynamic UE-Slice-MBR).

Alternatively, for the case where there is a single link over which DL traffic can be throttled for a network slice (e.g. on a router on the data network, which is configured to throttle the DL traffic in the network slice) a serving PCF may control only the dynamic maximum bit rate per UE for a network slice (dynamic UE-Slice-MBR) in the UL or the number of UEs with a PDU session in the network slice.

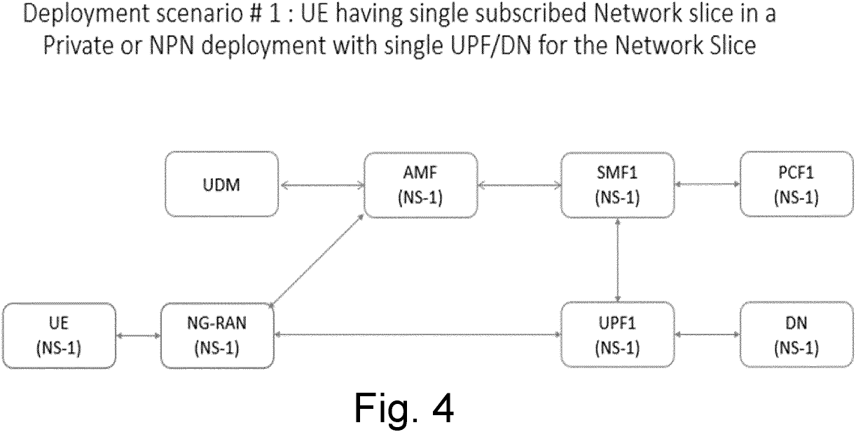

FIG. 4 shows a schematic representation of a first deployment scenario wherein a terminal has a single subscribed network slice in a private network or a non-private network deployment with a single user plane function/data network for the network slice.

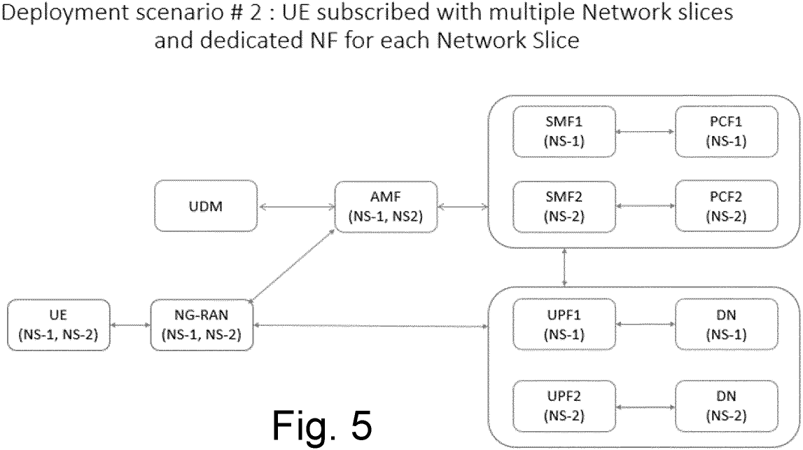

FIG. 5 shows another schematic representation of a second deployment scenario wherein a terminal subscribes with multiple network slices and dedicated network functions for each network slice.

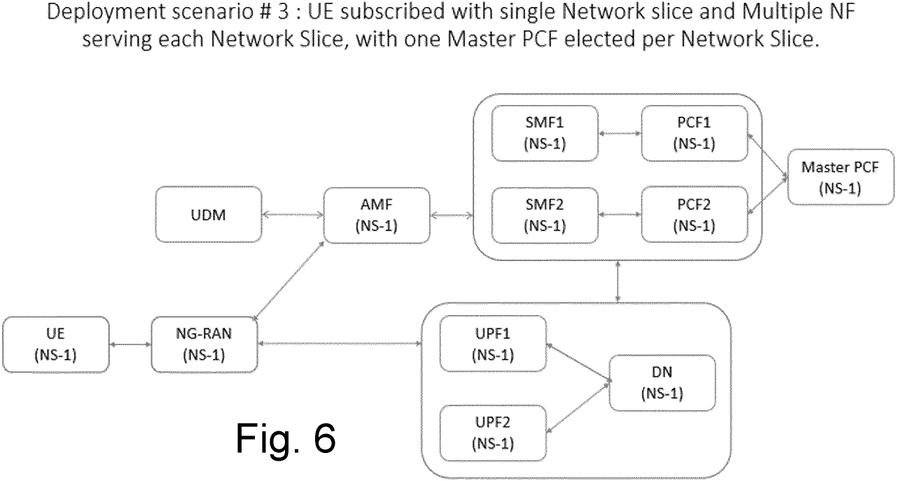

FIG. 6 shows a schematic representation of a third deployment scenario wherein a terminal subscribes with a single network slice and multiple network functions serve each network slice with one master policy control function elected per network slice.

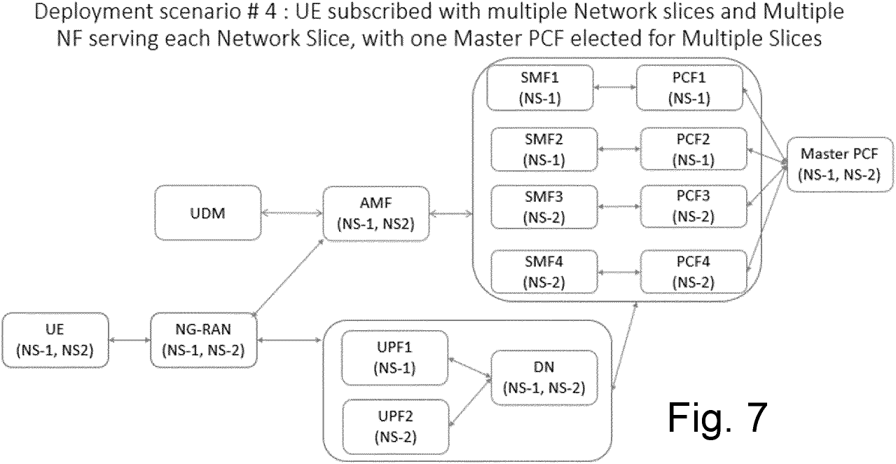

FIG. 7 shows a schematic representation of a fourth deployment scenario wherein a terminal subscribes with multiple network slices and multiple network function serve each network slice with one master policy control function elected for multiple network slices.

In the first and second deployment scenario, the single serving PCF will act as master PCF. In the third and fourth deployment scenario, a master PCF is selected among the serving PCFs. A master PCF may serve a single network slice or multiple network slices.

A master PCF may be configured based on GSMA parameters with an S-NSSAI identifier(S-NSSAI ID) and a maximum bit rate for a network slice (MBR/Slice).The master PCF may also be configured with a maximum number of UEs allowed to operate on the network slice it serves, as illustrated below:

| Max no of UE | S-NSSAI ID | MBR/slice |
|---|---|---|
| 50000 | NSSAI-1 | Max DL = 10Gbps Max UL = 2Gbps |
| 40000 | NSSAI-2 | Max DL = IGbps Max UL = 100Mbps |
| 30000 | NSSAI-3 | Max DL = 5Gbps Max UL = 500Mbps |

A master PCF may count the number of UEs operating on a network slice as follows.

A UE may initiate a PDU session establishment procedure indicating a S-NSSAI identifying the network slice. A serving PCF may indicate the PDU session creation (along with the S-NSSAI ID and a UE ID) to the master PCF. The master PCF may check if there is any existing PDU session for the UE ID. If no PDU session exists, then the master PCF may increment the number of UEs operating on the network slice. Else if one or more PDU session exists for the UE ID, the master PCF may only increment the number of PDU sessions on the network slice. The master PCF may not increment the number of UEs operating on the network slice.

A UE may initiate a PDU session release procedure. A serving PCF may indicate the PDU session release (along with the S-NSSAI ID and UE ID) to the master PCF. The master PCF may check if there is any more existing PDU session for the UE ID. If no PDU session exists (and the request was for the last PDU session of the UE), then the master PCF may decrement the number of UEs operating on the network slice.

Else if after releasing the PDU session, other PDU session exists for the UE, then the master PCF may only decrement a number of PDU sessions on the network slice. The master PCF may not decrement the number of UEs operating on the network slice.

A master PCF may adjust a dynamic maximum bit rate per UE for a network slice (dynamic UE-Slice-MBR) as follows.

For illustration purpose, let us assume the following initial configuration at the master PCF for S-NSSAI-1. Let us assume that no UE operates on the network slice.

| Max no of UE | S-NSSAI ID | MBR/slice | Dynamic UE-slice-MBR (assigned by the master PCF) |
|---|---|---|---|
| 100 | NSSAI-1 | Max DL = 10Gbps Max UL = 2Gbps | UE-Slice-MBR DL = 120Mbps UE-Slice-MBR UL = 24Mbps |

The dynamic maximum bit rate per UE for a network slice in the DL (dynamic UE-Slice-MBR DL) and the dynamic maximum bit rate per UE for a network slice in the UL (dynamic UE-Slice-MBR UL) may be assigned to all the PDU sessions created for the slice.

Let us assume the master PCF sets an upper threshold value in the DL to 9Gbps and an upper threshold value in the UL to 1.8 Gbps. The upper threshold value in the DL may be lower than a maximum aggregate bit rate for a network slice in the DL, which may be equal to 10Gbps. The upper threshold value in the UL may be lower than a maximum aggregate bit rate for a network slice in the UL, which may be equal to 2Gbps.

Let us assume the master PCF sets a lower threshold value in the DL to 6Gbps and a lower threshold value in the UL to 1.2 Gbps. The lower threshold value in the DL may be also lower than a maximum aggregate bit rate for a network slice in the DL, which may be equal to 10Gbps. The upper threshold value in the UL may be lower than a maximum aggregate bit rate for a network slice in the UL, which may be equal to 2Gbps.

The upper threshold value in the DL may be reached when 75 UEs operate on the network slice with the above dynamic maximum bit rate per UE for a network slice in the DL (i.e. 75 x 120Mbps = 9Gbps).

Likewise, the upper threshold value for the network slice in the UL may be reached when 75 UEs operate on the network slice with the above dynamic maximum bit rate per UE for a network slice in the UL (i.e. 75 x 24Mbps = 1.8Gbps).

| | | | | | |
|---|---|---|---|---|---|
| Max no of UE | S-NSSAI ID | MBR/Slice | Dynamic UE-Slice-MBR (assigned by the master PCF) | Count of no of UE (Active) | Aggregate Data rate (current utilization) |
| 100 | NSSAI-1 | Max DL = 10Gbps | UE-Slice-MBR DL = 120Mbps | 75 | Aggregate DL = 9Gbps |
| | | Max UL = 2Gbps | UE-Slice-MBR UL = 24Mbps | | Aggregate UL =1.8Gbps |

The master PCF may adjust the dynamic maximum bit rate per UE for a network slice in the DL (dynamic UE-Slice-MBR DL) from 120Mbps to 100 Mbps and the dynamic maximum bit rate per UE for a network slice in the UL (dynamic UE-Slice-MBR UL) from 24Mbps to 20Mps, that is the master PCF may decrease the dynamic maximum bit rate per UE for a network slice in the DL (dynamic UE-Slice-MBR DL) and the dynamic maximum bit rate per UE for a network slice in the UL (dynamic UE-Slice-MBR UL).

The master PCF may notify the serving PCF about the adjusted dynamic maximum bit rate per UE for a network slice in the DL (dynamic UE-Slice-MBR DL) and the adjusted dynamic maximum bit rate per UE for a network slice in the UL (dynamic UE-Slice-MBR UL).

The master PCF may provide the serving PCF with an indication that the upper threshold value in the UL has been reached.

The serving PCF may use the adjusted dynamic maximum bit rate per UE for a network slice in the DL (dynamic UE-Slice-MBR DL) and the adjusted dynamic maximum bit rate per UE for a network slice in the UL (dynamic UE-Slice-MBR UL) for new PDU session establishment procedures.

Depending on the signalling load (i.e. whether aggregate bit rate for a network slice is lower than the upper threshold value) and UE activity (i.e. number of UEs operating on a network slice), a serving PCF may initiate network initiated PDU session modification for the already operating UEs to apply an adjusted dynamic maximum bit rate per UE for a network slice (dynamic UE-Slice-MBR) in the DL or the UL, so that it does not impact in anyways to a 5GS system load.

After some time, let us assume the lower threshold value in the DL and/or the lower threshold value in the UL are reached based on the number of UEs operating on the network slice being equal to 60 (i.e. 60x .100Mbps = 6Gbps and 60 x 20 = 1.2Gbps).

| | | | | | |
|---|---|---|---|---|---|
| Max no of UE | S-NSSAI ID | MBR/Slice | Dynamic UE-Slice-MBR (assigned by the master PCF) | Count of no of UE (Active) | Aggregate Data rate (current utilization) |
| 100 | NSSAI-1 | Max DL = 10Gbps | UE-Slice-MBR DL = 100Mbps | 60 | Aggregate DL = 6Gbps |
| | | Max U1 = 2Gbps | UE-Slice-MBR UL = 20Mbps | | Aggregate UL =1.2Gbps |

The master PCF may adjust the dynamic maximum bit rate per UE for a network slice in the DL (dynamic UE-Slice-MBR DL) and the dynamic maximum bit rate per UE for a network slice in the UL (dynamic UE-Slice-MBR UL), for example the master PCF may increase the dynamic maximum bit rate per UE for a network slice in the DL (dynamic UE-Slice-MBR DL) and the dynamic maximum bit rate per UE for a network slice in the UL (dynamic UE-Slice-MBR UL).

The master PCF may notify the serving PCF about the adjusted dynamic maximum bit rate per UE for a network slice in the DL (dynamic UE-Slice-MBR DL) and the adjusted dynamic maximum bit rate per UE for a network slice in the UL (dynamic UE-Slice-MBR UL).

Additionally or alternatively, the master PCF may not adjust the dynamic maximum bit rate per UE for a network slice in the DL (dynamic UE-Slice-MBR DL) and the dynamic maximum bit rate per UE for a network slice in the UL (dynamic UE-Slice-MBR UL) and may adjust the maximum number of UEs allowed to operate on the network slice, for example by rejecting additional PDU sessions with the cause “upper threshold value in the UL and/or the DL reached”.

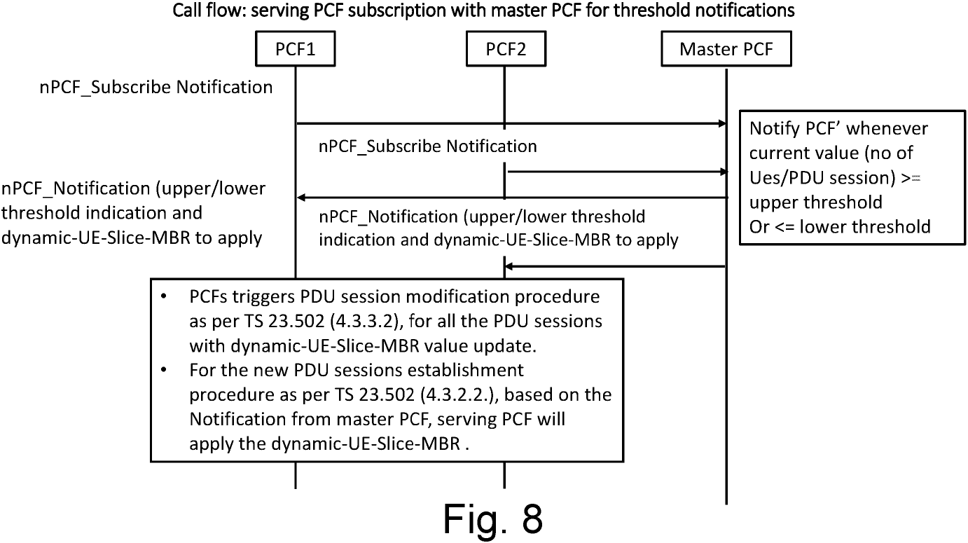

FIG. 8 shows a schematic representation of a signalling diagram of a process for providing notifications from a master PCF to a serving PCF.

One or more serving PCFs for a network slice may subscribe for notification with a master PCF. Whenever the upper threshold value or the lower threshold value is reached, the master PCF may notify that the upper threshold value in UL and/or DL or the lower threshold value in UL and/or DL is reached. The master PCF may also indicate an adjusted dynamic maximum bit rate per UE for a network slice in the DL (dynamic UE-Slice-MBR DL) and/or an adjusted dynamic maximum bit rate per UE for a network slice in the UL (dynamic UE-Slice-MBR UL).

The adjusted dynamic maximum bit rate per UE for a network slice in the DL (dynamic UE-Slice-MBR DL) and/or an adjusted dynamic maximum bit rate per UE for a network slice in the UL (dynamic UE-Slice-MBR UL) may be applied to new PDU sessions and for network triggered PDU modification for existing sessions.

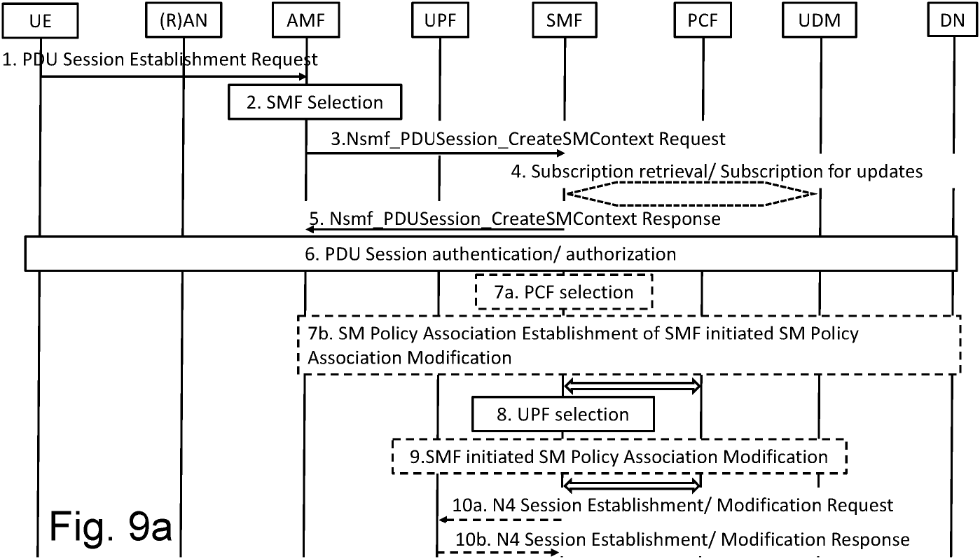

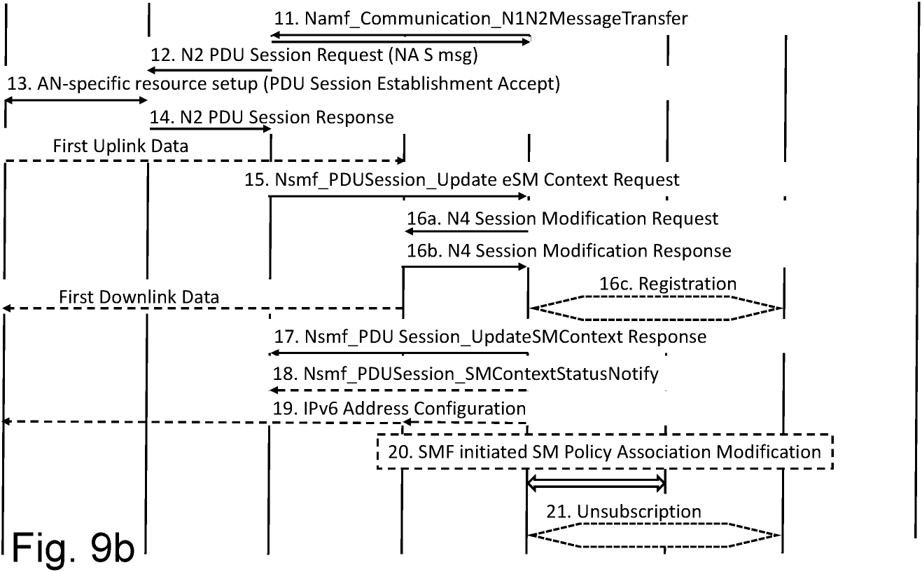

FIGS. 9a and 9b show a schematic representation of a signalling diagram of a process for establishing a packet data unit session as per FIG. 4.3.2.2.1-1 from TS 23.502. In step 12, the (R)AN may receive an adjusted dynamic maximum bit rate per UE for a network slice in the DL (dynamic UE-Slice-MBR DL) and/or an adjusted dynamic maximum bit rate per UE for a network slice in the UL (dynamic UE-Slice-MBR UL) from the serving PCF via the SMF and the AMF. In this way, the (R)AN may enforce the adjusted dynamic maximum bit rate per UE for a network slice in the DL (dynamic UE-Slice-MBR DL) and/or the adjusted dynamic maximum bit rate per UE for a network slice in the UL (dynamic UE-Slice-MBR UL) for future PDU sessions for that network slice.

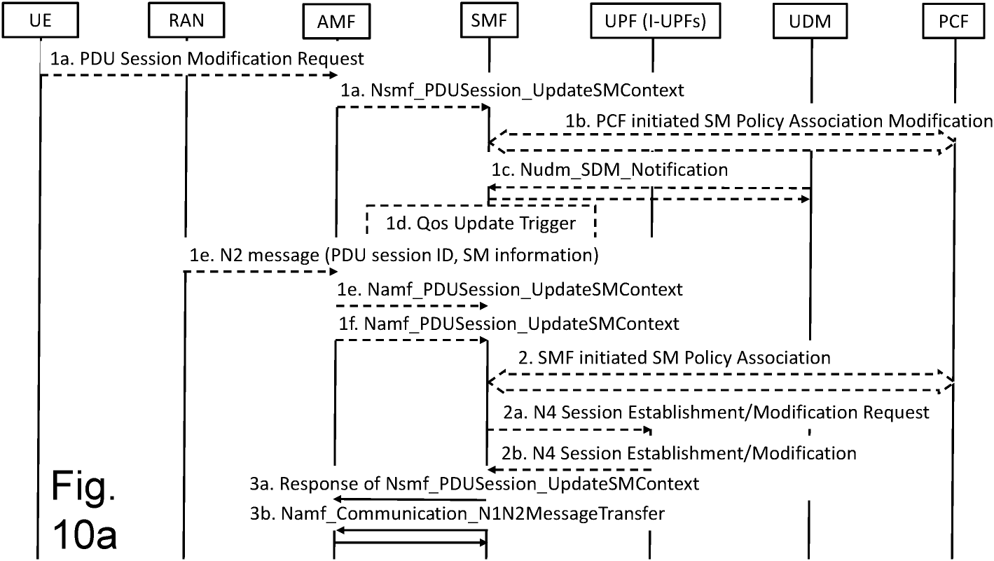

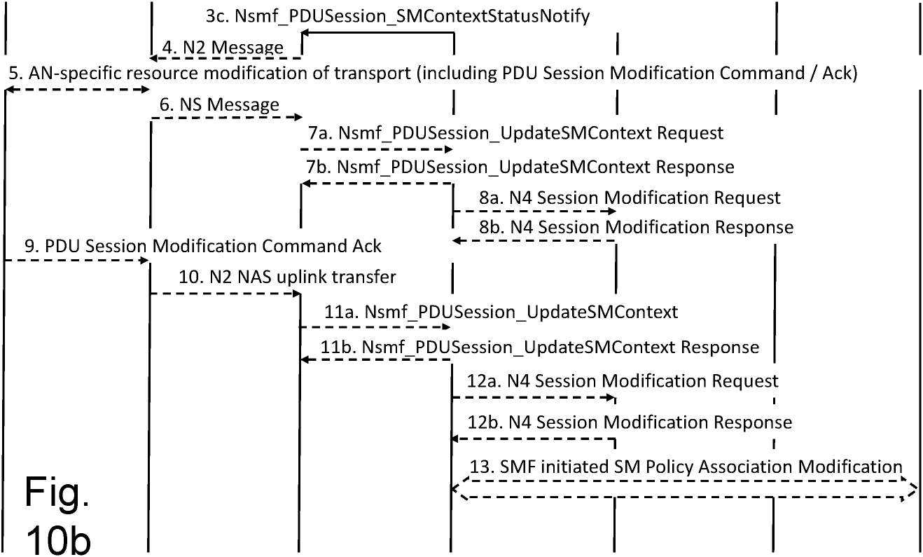

FIGS. 10a and 10b show a schematic representation of a signalling diagram of a process for modifying a packet data unit session as per FIG. 4.3.3.2-1 from TS 23.502. In step 4, the (R)AN may receive an adjusted dynamic maximum bit rate per UE for a network slice in the DL (dynamic UE-Slice-MBR DL) and/or an adjusted dynamic maximum bit rate per UE for a network slice in the UL (dynamic UE-Slice-MBR UL) from the serving PCF via the SMF and the AMF. In this way, the (R)AN may enforce the adjusted dynamic maximum bit rate per UE for a network slice in the DL (dynamic UE-Slice-MBR DL) and/or the adjusted dynamic maximum bit rate per UE for a network slice in the UL (dynamic UE-Slice-MBR UL) for modifying existing PDU sessions for that network slice.

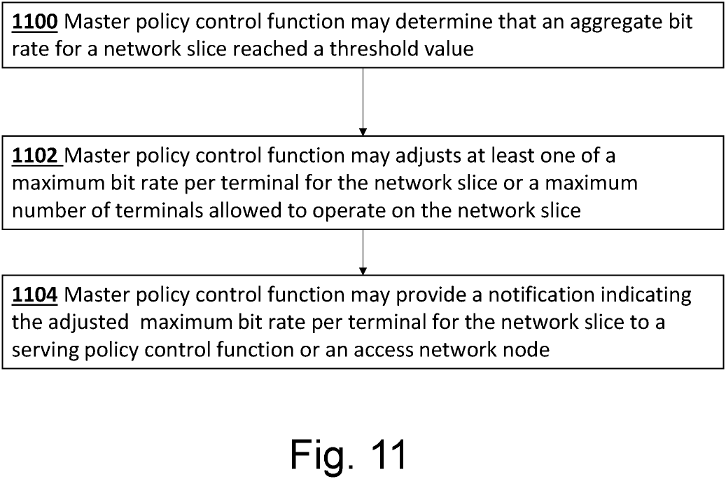

FIG. 11 shows a schematic representation of a block diagram of a method performed by a master policy control function for providing a notification indicating an adjusted maximum bit rate per terminal for a network slice on the network slice to a serving policy control function or an access network node.

In step 1100 a master policy control function may determine that an aggregate bit rate for a network slice reached a threshold value. The threshold value may be an upper threshold value and/or a lower threshold value.

The aggregate bit rate for a network slice may comprise an aggregate bit rate for a network slice for an uplink. The threshold value may comprise a threshold value for the uplink. The maximum bit rate per terminal for the network slice may comprise a maximum bit rate per terminal for the network slice for the uplink.

The aggregate bit rate for a network slice may comprise an aggregate bit rate for a network slice for a downlink. The threshold value may comprise a threshold value for the downlink. The maximum bit rate per terminal for the network slice may comprise a maximum bit rate per terminal for the network slice for the downlink.

The master policy control function may determine that an aggregate bit rate for a network slice reached a threshold value based on a number of terminals operating on the network slice and the maximum bit rate per terminal for the network slice.

The master policy control function may determine the number of terminals operating on the network slice.

The master policy control function may determine that a first packet data unit session is established by a terminal for the network slice. The master policy control function may increment the number of terminals operating on the network slice.

The master policy control function may determine that a last packet data unit session is released by a terminal for the network slice. The master policy control function may decrement the number of terminals operating on the network slice.

In step 1102 the master policy control function may adjust at least one of a maximum bit rate per terminal for the network slice or a maximum number of terminals allowed to operate on the network slice. The master policy control function may adjust the maximum number of terminals allowed to operate on the network slice whilst abstaining from adjusting the maximum bit rate per terminal for the network slice (i.e. the maximum bit rate per terminal for the network slice may remain static).

The maximum bit rate per terminal for the network slice may be different from a subscribed maximum bit rate per terminal for the network slice.

In step 1104 the master policy control function may provide a notification indicating the adjusted maximum bit rate per terminal for the network slice .

Additionnally or alternatively, the master policy control function may enforce the maximum number of terminals allowed to operate on the network slice. For example, the master policy control function may accept or refuse a new PDU session established by a terminal for the network slice.

The master policy control function may be a single policy control function serving the network slice. The master policy control function may provide the notification indicating the adjusted maximum bit rate per terminal for the network slice to an access network node.

The master policy control function may be one of a plurality of policy control functions serving the network slice. The master policy control function may provide the notification indicating at least one of the adjusted maximum bit rate per terminal for the network slice to another one of the plurality of policy control function registered with the master policy control function to receive the notification.

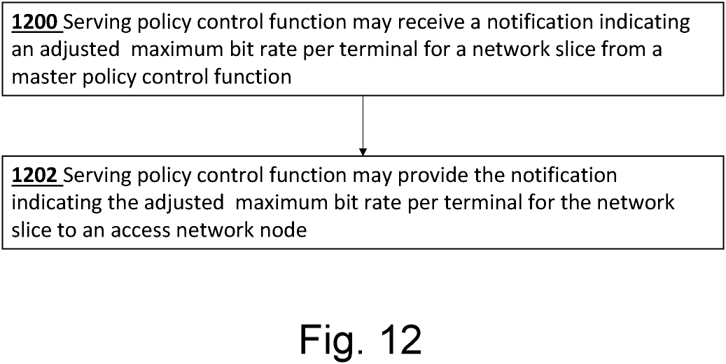

FIG. 12 shows a schematic representation of a block diagram of a method performed by a serving policy control function for providing a notification indicating an adjusted maximum bit rate per terminal for a network slice to an access network node.

In step 1200 a serving policy control function may receive a notification indicating an adjusted maximum bit rate per terminal for a network slice f.

The serving policy control function may register with a master policy control unction to receive the notification.

In step 1204 the serving policy control function may provide the notification indicating the adjusted maximum bit rate per terminal for the network slice to an access network node.

Subsequently, the serving policy control function may trigger a packet data unit session modification procedure based on the adjusted maximum bit rate per terminal for the network slice. The serving policy control function may trigger a packet data unit session establishment procedure based on the adjusted maximum bit rate per terminal for the network slice.

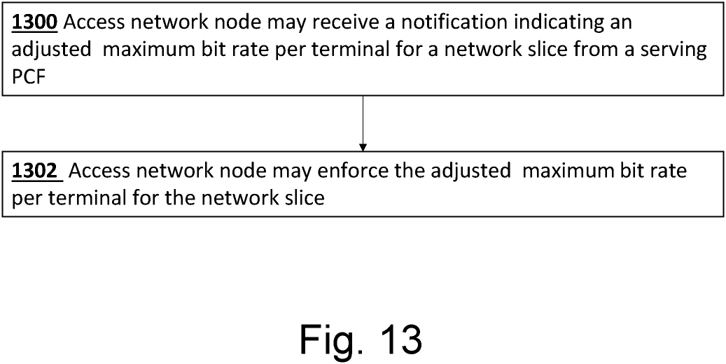

FIG. 13 shows a schematic representation of a block diagram of a method performed by an access network node for enforcing an adjusted maximum bit rate per terminal for a network slice.

In step 1300 an access network node may receive a notification indicating an adjusted maximum bit rate per terminal for a network slice from a serving PCF

In step 1302 the access network node may enforce the adjusted maximum bit rate per terminal for the network slice.

The access network node may trigger a packet data unit session modification procedure based on the adjusted maximum bit rate per terminal for the network slice.

The access network node may trigger a packet data unit session establishment procedure based on at least one of the adjusted maximum bit rate per terminal for the network slice.

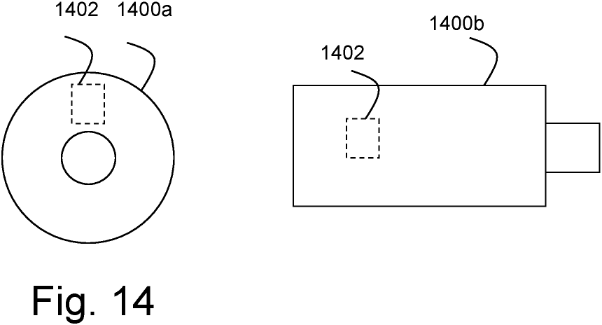

FIG. 14 shows a schematic representation of non-volatile memory media 1400a (e.g. computer disc (CD) or digital versatile disc (DVD)) and 1400b (e.g. universal serial bus (USB) memory stick) storing instructions and/or parameters 1402 which when executed by a processor allow the processor to perform one or more of the steps of the methods of FIGS. 11 to 13.

It is noted that while the above describes example embodiments, there are several variations and modifications which may be made to the disclosed solution without departing from the scope of the present invention.

It will be understood that although the above concepts have been discussed in the context of a 5GS, one or more of these concepts may be applied to other cellular systems.

The embodiments may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software stored in a memory and executable by at least one data processor of the involved entities or by hardware, or by a combination of software and hardware. Further in this regard it should be noted that any procedures, e.g., as in FIGS. 11 to 13, may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Alternatively or additionally some embodiments may be implemented using circuitry. The circuitry may be configured to perform one or more of the functions and/or method steps previously described. That circuitry may be provided in the base station and/or in the communications device.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of exemplary and non-limiting examples a full and informative description of some embodiments However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

1. An apparatus comprising:
at least one processor; and
at least one memory including computer program code;
the at least one memory and the computer program code configured to, with the at least one processor, cause the apparatus at least to:
determine that an aggregate bit rate for a network slice reached a threshold value; and
adjust at least one of a maximum bit rate per terminal for the network slice or a maximum number of terminals allowed to operate on the network slice.

2. The apparatus of claim 1, wherein the at least one memory and the computer program code are configured to, with the at least one processor, cause the apparatus at least to:
adjust the maximum number of terminals allowed to operate on the network slice while abstaining from adjusting the maximum bit rate per terminal for the network slice.

3. The apparatus of claim 1, wherein the threshold value comprises a lower threshold value and/or an upper threshold value.

4. The apparatus of claim 1, wherein determining that an aggregate bit rate for a network slice reached the threshold value comprises:
determining that an aggregate bit rate for a network slice reached the threshold value based on a number of terminals operating on the network slice and the maximum bit rate per terminal for the network slice.

5. The apparatus of claim 1, wherein the at least one memory and the computer program code are configured to, with the at least one processor, cause the apparatus at least to:
enforce the maximum number of terminals allowed to operate on the network slice.

6. The apparatus of claim 1, wherein the at least one memory and the computer program code are configured to, with the at least one processor, cause the apparatus at least to:
provide a notification indicating the adjusted maximum bit rate per terminal for the network slice.

7. The apparatus of claim 1, wherein the at least one memory and the computer program code are configured to, with the at least one processor, cause the apparatus at least to:
determine the number of terminals operating on the network slice.

8. The apparatus of claim 1, wherein determining the number of terminals operating on the network slice comprises:
determining that a first packet data unit session is established by a terminal for the network slice; and
increment the number of terminals operating on the network slice.

9. The apparatus of claim 1, wherein determining the number of terminals operating on the network slice comprises:
determining that a last packet data unit session is released by a terminal for the network slice; and
decrement the number of terminals operating on the network slice.

10. The apparatus of claim 1, wherein the apparatus comprises a policy control function serving the network slice.

11. The apparatus of claim 10, wherein the apparatus iscomprises a single policy control function serving the network slice.

12. The apparatus of claim 10, wherein the apparatus iscomprises one of a plurality of policy control functions serving the network slice; and
wherein another one of the plurality of policy control function is registered with the apparatus to receive the notification indicating the adjusted maximum bit rate per terminal for the network slice from the apparatus.

13. The apparatus of claim 1, wherein the maximum bit rate per terminal for the network slice is different from a subscribed maximum bit rate per terminal for the network slice.

14. The apparatus of claim 1,
wherein the aggregate bit rate for the network slice is an aggregate bit rate for the network slice for an uplink;
wherein the threshold value is a threshold value for the uplink; and
wherein the maximum bit rate per terminal for the network slice comprises a maximum bit rate per terminal for the network slice for the uplink.

15. The apparatus of claim 1,
wherein the aggregate bit rate for the network slice is an aggregate bit rate for the network slice for a downlink;
wherein the threshold value is a threshold value for the downlink; and
wherein the maximum bit rate per terminal for the network slice comprises a maximum bit rate per terminal for the network slice for the downlink.

16-19. (canceled)

20. An apparatus comprising:
at least one processor; and
at least one memory including computer program code;
the at least one memory and the computer program code configured to, with the at least one processor, cause the apparatus at least to:
receive a notification indicating an adjusted maximum bit rate per terminal for a network slice; and
enforce the adjusted maximum bit rate per terminal for the network slice.

21. A method comprising:
determining that an aggregate bit rate for a network slice reached a threshold value; and
adjusting at least one of a maximum bit rate per terminal for the network slice or a maximum number of terminals allowed to operate on the network slice.

22. (canceled)

23. A method comprising:
receiving a notification indicating an adjusted maximum bit rate per terminal for a network slice; and
enforcing the adjusted maximum bit rate per terminal for the network slice.

24. A non-transitory computer-readable medium comprising computer executable instructions encoded thereon which, when run on one or more processors, perform the method of claim 21.
